(19) United States
(12) Patent Application Publication
(10) Pub. No.: US 2008/0178103 A1
(43) Pub. Date: Jul. 24, 2008

(54) Copying data between computer systems

(76) Inventor: Robert Campbell, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/656,770

(22) Filed: Jan. 23, 2007

(51) Int. Cl. G06F 3/048; G06F 15/16

(52) U.S. Cl. 715/764; 709/203

(57) ABSTRACT

In one embodiment, a method to copy data from a first computer system to a second computer system comprises receiving, in a first computer system, a first signal initiated by an input/output device, wherein the first signal indicates a cut operation or a copy operation on at least one selected object displayed on the first computer system. In response to the first signal, the at least one selected object is copied to a memory buffer in a remote device coupled to the first computing system. A second signal initiated by the input/output device is received in a second computer system, wherein the second signal indicates a paste operation for at least one selected object. In response to the second signal, the at least one selected object is retrieved from the memory buffer in the remote device and inserted into a memory location on the second computer system.

### BACKGROUND

Independent computer systems may be coupled via a switching device such as a console switch. Similarly, input/output (I/O) devices such as, e.g., monitors, a keyboard, a mouse, and the like may be coupled to the computing devices via the switching device. Coupled computer systems may then be used contemporaneously. For example, a user may execute a word processing application in a first computing system and a database application in a second computing system. A convenient way move data between applications executed on the independent computer systems would find utility.

### BRIEF DESCRIPTION OF THE DRAWINGS

FIG. 1 is a schematic illustration of a coupled computer systems, according to embodiments.

FIG. 2 is a schematic illustration of coupled computing systems, according to embodiments.

FIG. 3 is a flowchart illustrating operations to copy data between computer systems according to embodiments.

FIG. 4 is a schematic illustration of coupled computing systems, according to embodiments.

FIG. 5 is a flowchart illustrating operations to copy data between computer systems according to embodiments.

### DETAILED DESCRIPTION

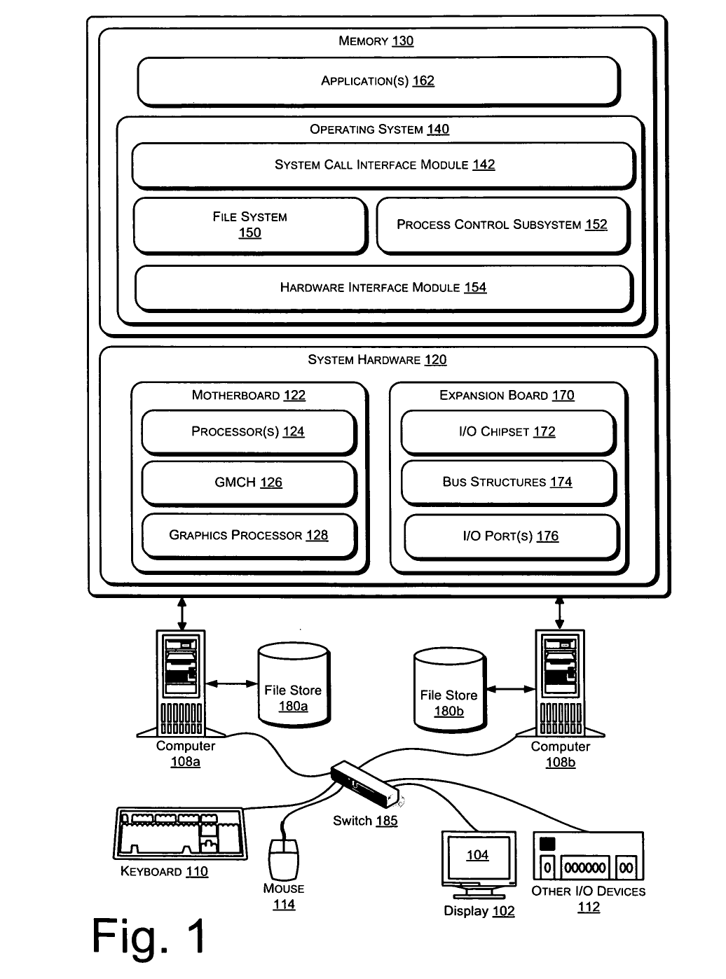

FIG. 1 is a schematic illustration of coupled computer systems 108a, 108b, which may be referred to generally by reference numeral 108. For clarity, the various components of computers 108 are not duplicated in FIG. 1. The computers 108 each comprise system hardware 120 and random access memory and/or read-only memory 130. Computer systems 108 each comprise file stores 180a, 180b, referred to collectively by reference numeral 180, communicatively connected to computers 108a. File stores 180 may be internal such as, e.g., one or more hard drives, or external such as, e.g., one or more external hard drives, network attached storage, or a separate storage network.

In some embodiments, system hardware 120 comprises a motherboard 122 and at least one expansion boards 170. Motherboard 122 hosts a plurality of components comprising at least one processor 124, a graphics and memory control hub (GMCH) 126, and a graphics processor. Motherboard 122 further comprises sockets to receive the various components mounted on motherboard 122 and circuit traces to provide electrical connections between the components.

In some embodiments, expansion board 170 may be an input/output (I/O) board. Expansion board 170 may include an I/O chipset such as, for example, a PCI-Express (PCIE) chipset 172, and bus structures 174 and one or more I/O ports 176. In some embodiments expansion board may include components which provide different functionality.

Memory 130 comprises an operating system 140 for managing operations of computer 108. Operating system 140 comprises a hardware interface module 154 that provides an interface to system hardware 120. At least one or more file systems 150 to manage files used in the operation of computer 108, and a process control subsystem 152 that manages processes executing on computer 108. Operating system 140 further comprises a system call interface module 142 that provides an interface between the operating system 140 and one or more applications executing on the computer system.

In operation, applications 162 executing on computer 108 make calls to the system call interface module 142 to execute one or more commands on the computer's processor. The system call interface module 142 invokes the services of the file systems 150 to manage the files required by the command(s) and the process control subsystem 152 to manage the process required by the command(s). The file system 150 and the process control subsystem 152, in turn, invoke the services of the hardware interface module 154 to interface with the system hardware 120.

The computer systems 108 may be coupled via a switching device 185 such as, for example, a console switch. As used herein, the term console refers to a collection of input/output devices such as, e.g., a display, 102, a keyboard, 110, a mouse 114, or other I/O devices 112. A console may be coupled to the computer systems 108 via the switch device 185. Other input/output device(s) may include a touch screen, a voice-activated input device, a track ball, and any other device that enables the computer systems to receive input from a developer and/or a user.

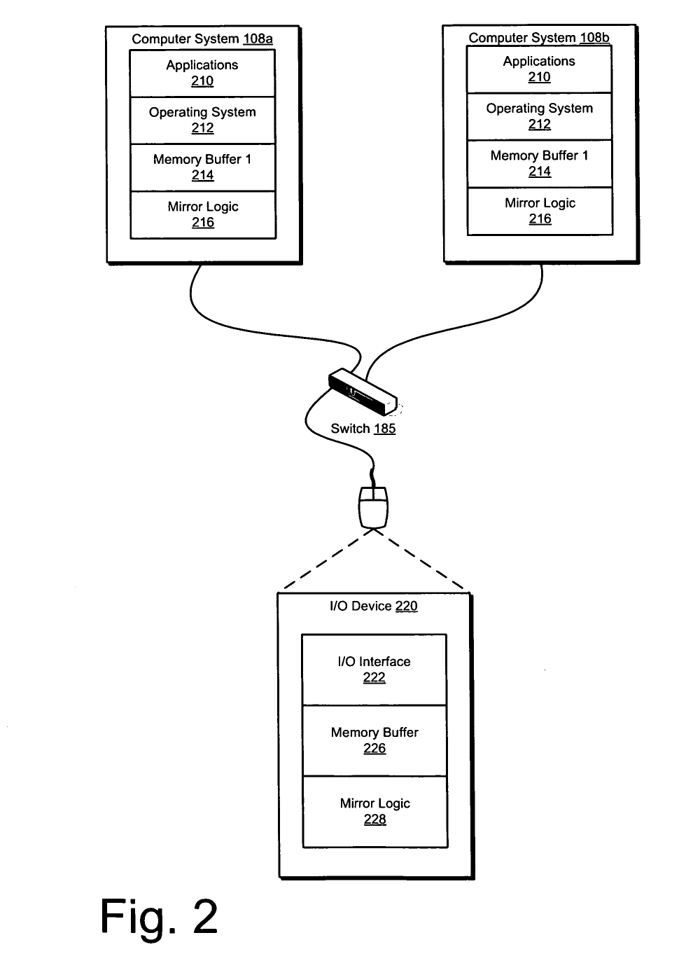

FIG. 2 is a schematic illustration of coupled computing systems, according to embodiments. Referring to FIG. 2, the computer systems 108a, 108b are coupled by switch 185. Computers 108 comprise one or more applications that utilize the services of operating system 212. The operating system 212 in computer system 108a may be the same operating system or a different operating system than the operating system 212 in computer system 108b. Computers 108 further comprise a memory buffer 216 and mirror logic modules 216.

Input/output device 220 is coupled to computers 108 via switch 185. In FIG. 2, input/output device 220 is embodied as a mouse. However, in the input/output device 220 may be embodied as a keyboard or as another input/output device. Input/output device 220 comprises an input/output interface 222, a memory buffer 226, and mirror logic module 228.

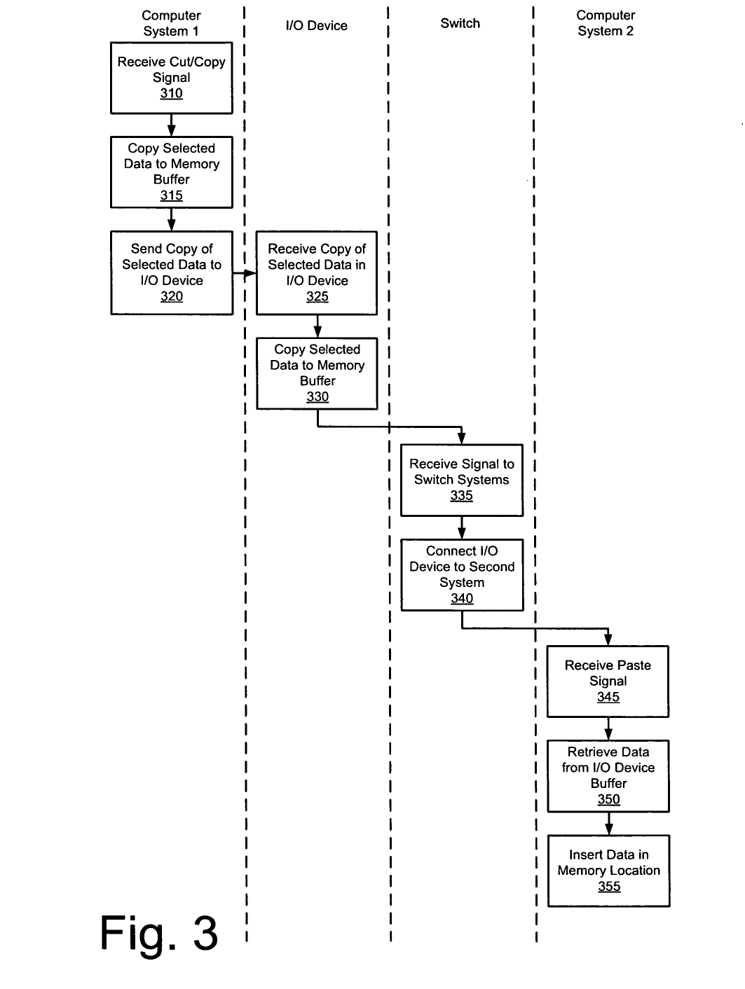

Mirror logic modules 216, 228 may be embodied as logic instructions stored in a computer readable medium. When executed by a processor, the logic instructions implement operations to copy data between computer systems 108a and 108b. FIG. 3 is a flowchart illustrating operations to copy from a first computer system to a second computer system according to embodiments. This description designates computer system 108a as the first computer system and computer system 108b as the second computer system. This designation is arbitrary; either computer system could be designated as the first computer system or the second computer system.

Referring to FIG. 3, at operation 310 the first computer system 108a receives a signal for a cut operation or a copy operation. In some embodiments the signal may be generated by a user of the system interacting with an input/output device such as a mouse or a keyboard. For example, referring to FIG. 2, a user executing an application 210 on the first computer system 108a may select at least one object displayed on a display of computer system 108a and initiate a cut or copy operation with the input/output device. As used herein, the term “object” may refer to an alphanumeric character, a picture, a drawing, or any other graphical object that may be displayed on a computer monitor.

At operation 315 the selected data is copied to the memory buffer in the first computer system. For example, in response to the cut or copy operation the operating system 212 copies the selected objects into memory buffer 214. At operation 320 a copy of the selected data is sent to the input/output device. In the embodiment depicted in FIG. 2 the mirror logic 216 sends a copy of the data stored in memory buffer to input/output device 220 via switch 185.

At operation 325 a copy of the data is received in the input/output device 220, and at operation 330 the data is copied to a memory buffer 226 in the input/output device 220. In the embodiment depicted in FIG. 2, the switch 185 sends a copy of the selected data to the input/output device 220. The selected data is received via the input/output interface 222 and mirror logic 228 copies the selected data into memory buffer 226.

At operation 335 a signal is received to switch the computer system. For example, a user of the system may generate a signal through an input/output device which indicates that that the user desires to connect the input/output device to the second computer system 108b. The signal is transmitted to the switch 185 which, at operation 340, connects the input/output device 220 to the second computer system 108b.

At operation 345 the second computer system 108b receives a paste signal initiated by the input/output device. For example, a user may choose to paste the selected data cut from the application executing on the first computer system 108a into an application executing on second computer system 108b.

At operation 350 the second computer system retrieves the selected data from memory buffer 226 in input/output device 220, and at operation 355 the selected data is inserted into a memory location executing on the second computer system 108b. The selected data may then be presented to the second computer system 108b, which may act as if the data had been pasted from itself.

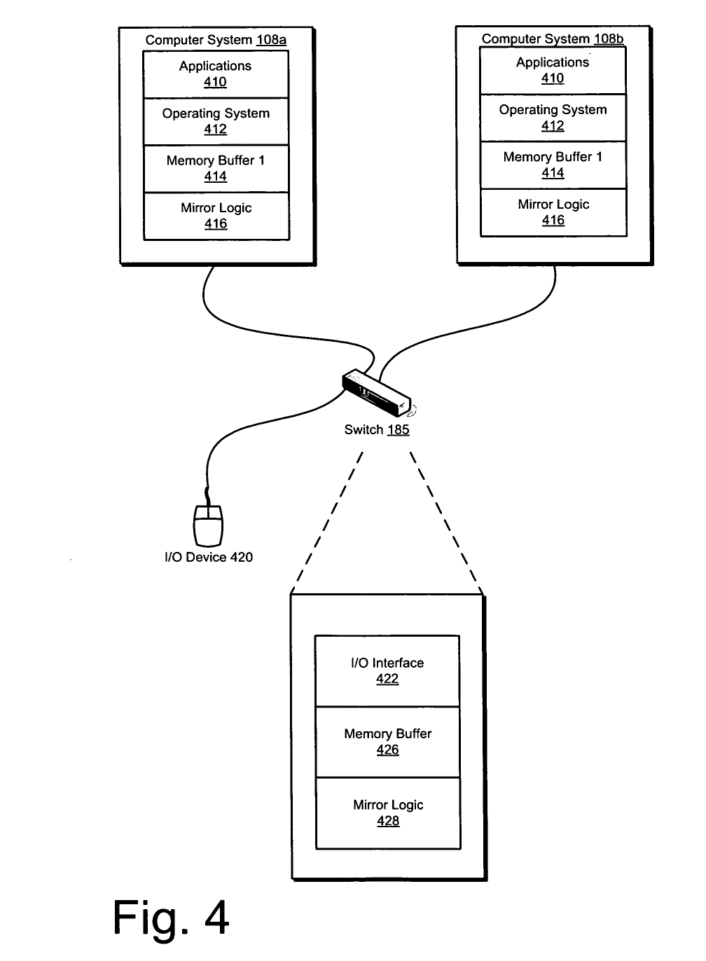

In some embodiments the memory and logic to manage data transfer between the first computer system 108a and the second computer system 108b may be positioned in the switch device 185, rather than the input/output device. FIG. 4 is a schematic illustration of coupled computing systems, according to embodiments. Referring to FIG. 4 the computer systems 108a, 108b are coupled by switch 185. Switch 185 comprises an input/output interface 422, a memory buffer 426, and mirror logic module 428. Computers 108 comprise one or more applications that utilize the services of operating system 412. Computers 108 further comprise a memory buffer 416 and mirror logic modules 416.

Input/output device 420 is coupled to computers 108 via switch 185. In FIG. 4, input/output device 420 is embodied as a mouse. However, in the input/output device 420 may be embodied as a keyboard or as another input/output device.

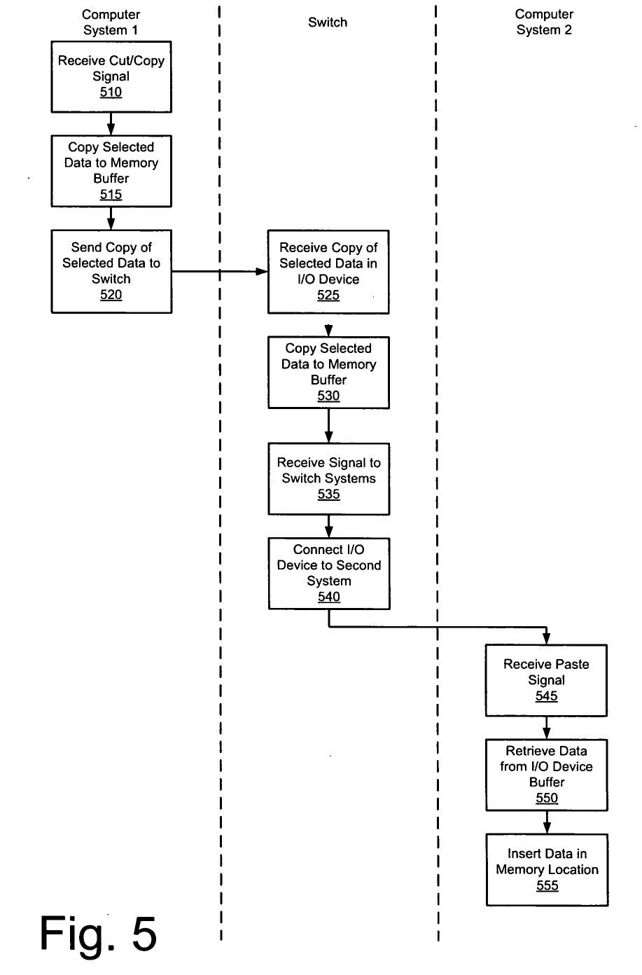

Mirror logic modules 416, 428 may be embodied as logic instructions stored in a computer readable medium. When executed by a processor, the logic instructions configure a processor to implement operations to copy data between computer systems 108a and 108b. FIG. 5 is a flowchart illustrating operations to copy from a first computer system to a second computer system according to embodiments. This description designates computer system 108a as the first computer system and computer system 108b as the second computer system. This designation is arbitrary; either computer system could be designated as the first computer system or the second computer system.

Referring to FIG. 5, at operation 510 the first computer system 108a receives a signal for a cut operation or a copy operation. In some embodiments the signal may be generated by a user of the system interacting with an input/output device such as a mouse or a keyboard. For example, referring to FIG. 4, a user executing an application 410 on the first computer system 108a may select at least one object displayed on a display of computer system 108a and initiate a cut or copy operation with the input/output device.

At operation 515 the selected data is copied to the memory buffer in the first computer system. For example, in response to the cut or copy operation the operating system 412 copies the selected objects into memory buffer 414. At operation 520 a copy of the selected data is sent to the switch 185. In the embodiment depicted in FIG. 4 the mirror logic 416 sends a copy of the data stored in memory buffer to switch 185.

At operation 525 a copy of the data is received in the switch 185, and at operation 530 the data is copied to a memory buffer in the switch 185. In the embodiment depicted in FIG. 4, the selected data is received via the input/output interface 422 and mirror logic 428 copies the selected data into memory buffer 426.

At operation 535 a signal is received to switch the computer system. For example, a user of the system may generate a signal through an input/output device which indicates that that the user desires to connect the input/output device to the second computer system 108b. The signal is transmitted to the switch 185 which, at operation 540, connects the input/output device 220 to the second computer system 108b.

At operation 545 the second computer system 108b receives a paste signal initiated by the input/output device. For example, a user may choose to paste the selected data cut from the application executing on the first computer system 108a into an application executing on second computer system 108b.

At operation 550 the second computer system retrieves the selected data from memory buffer 426 in switch 185, and at operation 555 the selected data is inserted into a memory location executing on the second computer system 108b. The selected data may then be presented to the second computer system 108b, which may act as if the data had been pasted from itself.

Reference in the specification to “one embodiment” or “an embodiment” means that a particular feature, structure, or characteristic described in connection with the embodiment is included in at least an implementation.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to copy data from a first computer system to a second computer system, comprising:
receiving, in a first computer system, a first signal initiated by an input/output device, wherein the first signal indicates a cut operation or a copy operation on at least one selected object displayed on the first computer system;
in response to the first signal, copying the at least one selected object to a memory buffer in a remote device coupled to the first computing system;
receiving, in a second computer system, a second signal initiated by the input/output device, wherein the second signal indicates a paste operation for at least one selected object;
in response to the second signal, retrieving the at least one selected object from the memory buffer in the remote device; and
inserting the at least one selected object into a memory location on the second computer system.

2. The method of claim 1, further comprising copying the at least one selected object into a memory buffer in the first computer system in response to the first signal.

3. The method claim 2, wherein copying the at least one selected object to a memory buffer in a remote device coupled to the first computing system comprises copying the contents of the memory buffer in the first computer system to a memory buffer in the input/output device.

4. The method of claim 1, wherein copying the at least one selected object to a memory buffer in a remote device coupled to the first computing system comprises copying the contents of the memory buffer in the first computer system a memory buffer in a switch.

5. The method of claim 1, wherein receiving, in a second computer system, a second signal initiated by the input/output device, wherein the second signal indicates a paste operation for at least one selected object comprises coupling the input/output device to the second computer system via a switch.

6. The method of claim 1, further comprising:
presenting the at least one selected object on a display module coupled to the second computer system.

7. A system, comprising:
a first computer system comprising a first memory buffer;
a second computer system comprising a second memory buffer;
an input/output device comprising a third memory buffer;
a switch to couple the input/output device to one of the first computer system or the second computer system,
wherein:
in response to a first signal initiated by the input/output device, at least one selected object displayed by the first computer system is stored in the third memory buffer;
in response to a second signal initiated by the input/output device, the input/output device is coupled to the second computing system; and
in response to a third signal initiated by the input/output device, the at least one selected object stored in the third memory buffer is copied to a memory location in the second computer system.

8. The system of claim 7, wherein the first computer system comprises first mirror logic to copy the at least one selected object into a memory buffer in the first computer system.

9. The system claim 7, wherein the first computer system comprises first mirror logic to copy the at least one selected object to a memory buffer in the input/output device.

10. The system of claim 7, wherein the input/output device comprises a mouse.

11. The system of claim 7, wherein the input/output device comprises a keyboard.

12. A system, comprising:
a first computer system comprising a first memory buffer;
a second computer system comprising a second memory buffer;
an input/output device;
a switch comprising a third memory buffer to couple the input/output device to one of the first computer system or the second computer system,
wherein:
in response to a first signal initiated by the input/output device, at least one selected object displayed by the first computer system is stored in the third memory buffer;
in response to a second signal initiated by the input/output device, the input/output device is coupled to the second computing system; and
in response to a third signal initiated by the input/output device, the at least one selected object stored in the third memory buffer is copied to a memory location in the second computer system.

13. The system of claim 12, wherein the first computer system comprises first mirror logic to copy the at least one selected object into a memory buffer in the first computer system.

14. The system claim 12, wherein the first computer system comprises first mirror logic to copy the at least one selected object to a memory buffer in the switch.

15. The system of claim 12, wherein the input/output device comprises a mouse.

16. The system of claim 12, wherein the input/output device comprises a keyboard.
